(19) United States
(12) Patent Application Publication
(10) Pub. No.: US 2025/0351057 A1
(43) Pub. Date: Nov. 13, 2025

(54) SPATIAL COMPUTE SERVICE MANAGEMENT AND CONFIGURATION

(71) Applicant: InterDigital Patent Holdings, Inc., Wilmington, DE (US)

(72) Inventors: Kevin Di Lallo, Laval (CA); Michael Starsinic, Newtown, PA (US); Michel Roy, Candiac (CA); Xavier De Foy, Kirkland (CA); Srinivas Gudumasu, Montreal (CA)

(73) Assignee: InterDigital Patent Holdings, Inc., Wilmington, DE (US)

(21) Appl. No.: 18/661,476

(22) Filed: May 10, 2024

(51) Int. Cl. H04W 48/16; H04W 8/22; H04W 28/24; H04W 64/00

(52) U.S. Cl. CPC H04W 48/16; H04W 8/22; H04W 28/24; H04W 64/003

(57) ABSTRACT

Systems, methods, and instrumentalities are disclosed herein for spatial compute service management and configuration. A wireless transmit/receive unit (WTRU) may send, to a first network node, a spatial compute discovery request that indicates the spatial sensing capability and a spatial computing capability of the WTRU. The WTRU may receive, from the first network node, a spatial compute discovery response that indicates a set of spatial compute services performable using the spatial sensing capability and the spatial computing capability of the WTRU, and a quality of service (QOS) requirement associated with a sensor data flow. The WTRU may send, to the first network node, a spatial compute configuration request that indicates a request for the first network node to configure a second network node such that the WTRU can use at least one spatial compute service from the set of spatial compute services.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein related to spatial compute service management and configuration.

A device (e.g., a wireless transmit/receive unit (WTRU) may include a processor configured to perform one or more actions. The WTRU may receive, from an application client, an indication of a spatial compute service characteristic. The WTRU may determine a spatial sensing capability of the WTRU based on the spatial compute service characteristic. The WTRU may send a spatial compute discovery request to a first network node. The spatial compute discovery request may indicate the spatial sensing capability and a spatial computing capability of the WTRU. The WTRU may receive a spatial compute discovery response from the first network node. The spatial compute discovery response may indicate a set of spatial compute services performable using the spatial sensing capability and the spatial computing capability of the WTRU, and a quality of service (QoS) requirement associated with a sensor data flow. The WTRU may send a QoS configuration request to a third network node. The QoS configuration request may indicate a request for the third network node to configure QoS for a PDU session that carries the sensor data flow. The WTRU may send a spatial compute configuration request to the first network node. The spatial compute configuration request may indicate a request for the first network node to configure a second network node such that the WTRU can use at least one spatial compute service from the set of spatial compute services. The WTRU may send data from a sensor in the PDU session.

The WTRU may receive a spatial compute configuration response that indicates that the second network node has been successfully configured. The WTRU may send spatial service request message to the second network node. The spatial service request message may include sensor data. The spatial service request message may indicate a request for the at least one spatial compute service to generate spatial data using the sensor data. The WTRU may receive a spatial service response message from the second network node. The spatial service response message may include the generated spatial data.

The spatial compute discovery request may be a first spatial compute discovery request. The WTRU may receive a spatial compute configuration response that indicates a failure to configure the second network node. In response to the spatial compute configuration response, the WTRU may send a second spatial compute discovery request to the first network node.

The WTRU may receive WTRU positioning information from the at least one spatial compute service. The WTRU may send the spatial compute discovery response to the application client. The spatial compute configuration request may indicate a processing capability of the WTRU.

The WTRU may receive a spatial compute configuration response that indicates successful configuration of the at least one spatial compute service, a spatial sensing data flow associated with the at least one spatial compute service, and a service flow associated with the at least one spatial compute service.

The spatial compute services in the set of spatial compute services may satisfy a criterion. The criterion may be at least one of a guaranteed bit rate, a packet error rate, a packet delay budget, a quality of service (QOS) value, a processing capability, a supported radio access technology, or a battery level.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example spatial compute management function in an application server and/or application client.

FIG. 3 illustrates an example spatial compute management function in an enabler server and/or enabler client.

FIG. 4 illustrates example signaling for spatial compute service registration.

FIG. 5 illustrates example signaling for spatial compute service discovery.

FIG. 6 illustrates example signaling for spatial compute service configuration.

### DETAILED DESCRIPTION

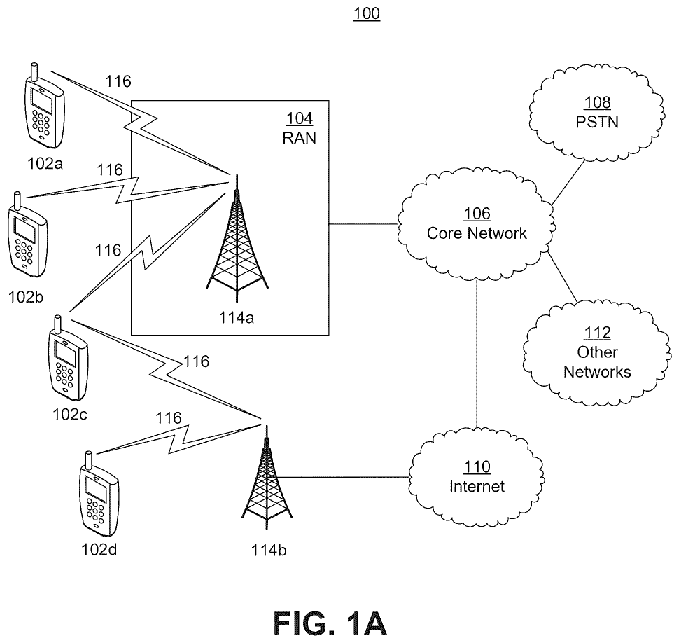

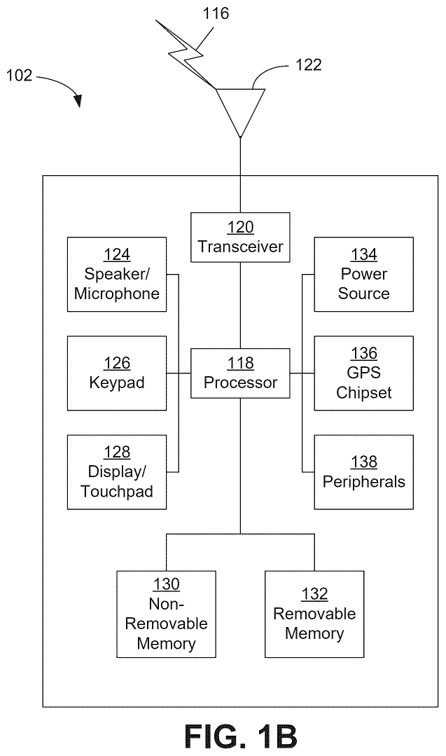

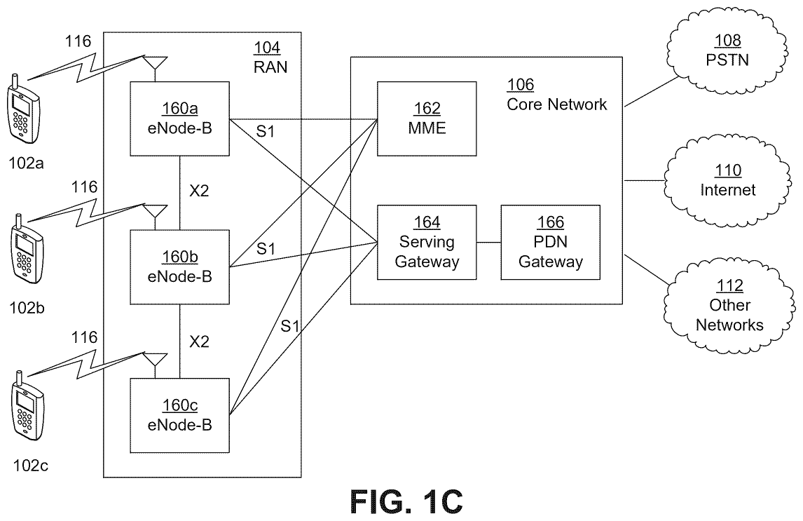

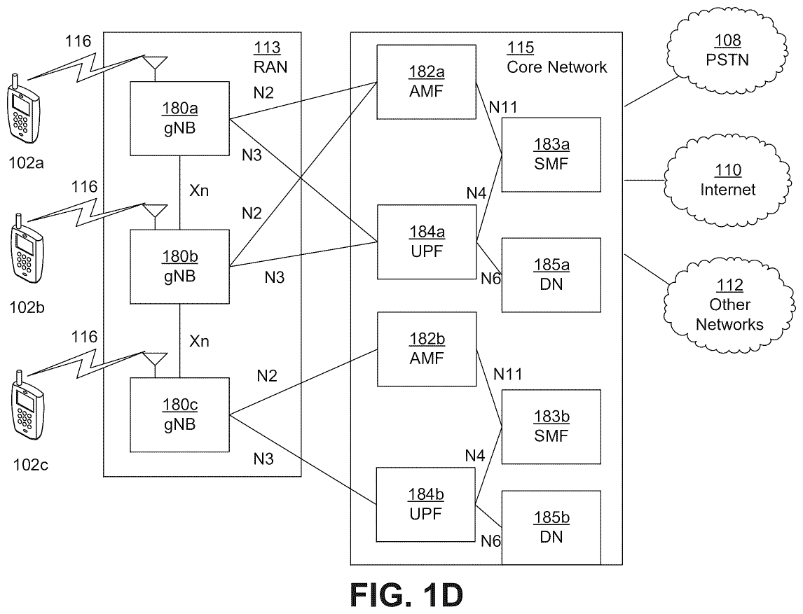

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter- eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

The terms “application server (AS)” and “application function (AF)” may be used interchangeably herein. “AS” and “spatial compute service” may be used interchangeably herein.

Feature(s) associated with spatial compute service management are provided herein.

An application client (AC) on a WTRU may have no means of discovering and/or configuring spatial compute services (e.g., according to application layer spatial computing specifications/requirements, spatial compute service capabilities, and/or WTRU capabilities, location, and/or state).

A service enablement layer function (e.g., SCMF) may provide spatial compute management capabilities (e.g., in the 5GS). If requested by an AC, a client enabler function (e.g., SCMF-C) may discover spatial compute services. For example, the spatial compute services may be registered to a server enabler function (e.g., SCMF-S). The spatial compute services may match the application-specific and/or WTRU-specific discovery filters and/or capabilities. The AC may select and/or configure a spatial compute service. For example, the AC may select and/or configure the spatial compute service according to AC specifications/requirements and/or capabilities, WTRU specifications/requirements and/or capabilities (e.g., processing, communication, spatial sensing), and/or spatial compute service specifications/requirements and capabilities.

A WTRU (e.g., an enabler client with SCMF-C capabilities) may perform one or more of the following actions to discover, select, and/or configure spatial compute services.

The SCMF-C may receive a spatial compute discovery request from an AC. The request may include information related to an AC. The SCMF-C and AC may be hosted on the same WTRU.

In an example, the request may indicate a spatial compute service characteristic. Spatial compute services may be associated with a range of characteristics that specify their nature and/or capabilities. A characteristic may be an identifier, such as a spatial compute service identifier. A characteristic may be a Spatial Compute Service Type, which may indicate a kind of spatial computing provided. For example, a type may be an environmental mapping, an augmented reality rendering, a spatial data analytic, and the like. A characteristic may be a connectivity and/or an address. For example, the connectivity a spatial compute service may be facilitated through a spatial compute service address, such as FQDN, URI, IP, an endpoint, and/or the like.

A characteristic may be or may indicate a spatial mapping capability, such as a localization capability, a mapping ability, and the like. A mapping ability may be a service's ability to create or update spatial maps. A localization capability may be a service's ability to determine a position and orientation of objects within a space, which may be used to enhance applications that overlay virtual objects onto the real world.

A characteristic may be whether a spatial compute task is performed client and/or server side. Client-side processing may offer quicker response times and reduce data transmission. Server-side processing may use more robust computational resources.

A characteristic may be whether a business model is associated with a service. For example, a characteristic may indicate that the spatial compute service uses a sponsored service business model, which may inform a user of potential costs associated with accessing the services (e.g., clarifying whether the service is free or monetized).

These characteristics collectively define the operational scope, technical potential, and commercial framework of spatial compute services, providing a foundation for compatibility, performance optimization, and enhanced user experiences.

The information may include spatial compute service information filters (e.g., that indicate the characteristics of the spatial compute services that the AC intends/wants to discover).

The information may indicate which sensor information the AC is able to access and use (e.g., if/when processing spatial compute service media received from an application server (AS). The AC may obtain sensor information (e.g., from sensors that are tethered to the WTRU or integrated with the WTRU). Example sensors may include: a camera, a microphone, a temperature sensor, a gyroscope, a GPS locator, and/or the like.

The information may indicate which sensor information the AC is able to share with an AS (e.g., so that the AS may process media content before sending the media content to the AC).

The AC may have been configured via a GUI. The AC may have interacted with the operating system of the WTRU. For example, the AC may interact with the operating system of the WTRU to determine which sensor information the AC is allowed to access and use for processing spatial compute service media, and/or which sensor information the AC is allowed to share with an application server.

The SCMF-C may send a spatial compute discovery request to the SCMF-S. The request may include the information that was received from the AC and/or WTRU Information.

The SCMF-C may receive a spatial compute discovery response from the SCMF-S. The response may include spatial compute service information for the discovered spatial compute services.

The spatial compute service information may indicate the sensor information requested (e.g., needed) by the AC (e.g., to perform client-side spatial computing), the sensor information to be provided to the AS (e.g., for spatial computing), and/or the QoS specifications (e.g., requirements) for media flows (e.g., spatial computing service flows, spatial sensor data flows) associated with the spatial compute services.

The SCMF-C may send a spatial compute discovery response or notification message to the AC. The response or notification message may include the information that was received from the SCMF-S.

The AC may (e.g., upon receiving the response or notification) select a spatial compute service from the list of discovered spatial compute services. The selection may be based on spatial compute service specifications/requirements and capabilities, AC specifications/requirements and capabilities, and/or WTRU specifications/requirements and capabilities.

The SCMF-C may receive a spatial compute configuration request from the AC. The request may include a spatial compute service configuration. The spatial compute service configuration may indicate the spatial compute services from which the AC has selected to receive (e.g., avail) services.

The SCMF-C may (e.g., upon receiving the request) contact a NEF to configure the QoS of media flows (e.g., spatial computing service flows, spatial sensor data flows, etc.) between the WTRU and AS. Contacting the NEF may include invoking an API of the NEF, providing the IP address of the AS, the QOS specifications/requirements of the AS, and/or an IP address or GPSI of the WTRU.

The SCMF-C may send a spatial compute configuration request to the SCMF-S to configure the selected spatial compute service. The request may include the information that was received from the AC, and/or WTRU information.

The SCMF-C may receive a spatial compute configuration response from the SCMF-S. The response may include an indication of success or failure.

The SCMF-C may send a spatial compute configuration response or notification message to the AC. The response or notification message may include the information that was received from the SCMF-S.

The AC may (e.g., upon receiving a successful response) use the endpoint information to contact the selected spatial compute service instance. The AC may send sensor information to the AS. The AC may receive media information from the AS. The AC may use sensor information to process the media information. The AC may display media information to the user.

The AC may (e.g., upon receiving a failure response) perform spatial compute service configuration using a different configuration and/or perform spatial compute discovery to discover new or updated spatial compute services.

An enabler server with SCMF-S capabilities may perform one or more of the following actions to manage and configure spatial compute services.

The SCMF-S may receive a spatial compute registration request from an application server (AS) to register information about a spatial compute service. The request may include spatial compute service information about the spatial compute service instance to register.

The SCMF-S may store the service information (e.g., upon receiving the request).

The SCMF-S may send a spatial compute registration response to the AS. The response may include an indication of success or failure.

The SCMF-S may receive a spatial compute discovery request from an enabler client with SCMF-C capabilities (e.g., a WTRU) to discover spatial compute services. The request includes spatial compute service information filters and WTRU information.

The SCMF-S may (e.g., upon receiving the request) identify spatial compute services that are registered to the SCMF-S. The spatial compute services may match the spatial compute service information filters provided in the discovery request.

The SCMF-S may perform a procedure with the 5GC or SEAL-LM to obtain the requesting WTRU location information.

The SCMF-S may obtain a list of WTRUs with spatial sensing capabilities in the WTRU location area.

The SCMF-S may send a spatial compute discovery response to the SCMF-C. The response may include spatial compute service information for the discovered spatial compute services.

The SCMF-S may receive a spatial compute configuration request from the SCMF-C. The request may include spatial compute service configuration to configure the spatial compute service.

The SCMF-S may (e.g., upon receiving the request) send the configuration information to the spatial compute service instance.

The SCMF-S may determine the configured service and sensor data flows. The SCMF-S may perform a procedure (e.g., with the 5GC) to configure QoS for the spatial compute service flows.

The SCMF-S may send a spatial compute configuration response to the SCMF-C. The response may include an indication of success or failure.

Example positioning systems are provided herein.

Positioning systems may be used to determine the geographic (e.g., longitude, latitude, altitude, etc.), three-dimensional (3D) position, and/or orientation (e.g., pitch, yaw, roll) of an object in space. Position may be a global position on Earth or a relative position with regard to a known reference point.

Geographic positioning systems may allow radio receivers to determine their geographic position (e.g., using microwave signals from satellites and/or land-based transmitters). For example, global navigation satellite systems (GNSS) (e.g., such as the Global Positioning System (GPS) may have global coverage. GNSS may enable radio receivers to determine their geographic position by measuring microwave signals from a set of satellites within range of the receiver. Geographic positioning accuracy may be within a few meters in outdoor settings. Geographic positioning accuracy may degrade (e.g., rapidly) in most underground or indoor settings.

Indoor positioning systems may be used to locate people or objects in indoor environments. These systems may use a network of devices to obtain device-specific positioning measurements (e.g., wireless technologies, magnetic fields, ultra-wideband). Indoor positioning systems may use a variety of vendor-specific positioning techniques to determine position. Positioning accuracy for indoor positioning systems may be deployment-and/or vendor-specific. Positioning accuracy for indoor positioning systems may vary from coarse to very precise (e.g., within a few centimeters).

Visual position systems may use image processing algorithms to compare images captured from a device (e.g., WTRU camera) with a database of captured images to determine the device position and orientation. Positioning accuracy may depend on the quality of the vendor-specific algorithms and/or on the quality and quantity of information available in the visual positioning database.

Cellular positioning systems may use reference signal measurements and cell tower triangulation to determine the position of a WTRU. This may be a technique (e.g., one of many techniques) used by mobile network operators (MNO) for WTRU positioning. A mobile device may support multiple radios and sensors (e.g., GPS, Wi-Fi) that may be leveraged by positioning systems, such as 3GPP positioning systems. In an example, a deployment, such as a 4G deployment, may support positioning architecture and protocols, such as the LTE positioning architecture and protocols, which may enable location servers in the network (e.g., to obtain both 3GPP and non-3GPP location information from WTRUs to determine more accurate WTRU positioning). In an example, a deployment, such as a 5G deployment may support the 5G positioning architecture. The 5G positioning architecture may include enhancements to the LTE positioning architecture. The 5G positioning architecture may include support for new radio (NR) sensing technologies (e.g., to provide even more accurate WTRU positioning).

Feature(s) associated with spatial mapping and localization are provided herein.

A spatial map may be a 3D digital model of a physical environment. Spatial mapping may include collecting and/or processing sensor measurements at various positions to construct a map of the environment. Spatial mapping may use (e.g., request (e.g., require)) sensor location information, wireless sensing data, and/or non-3GPP sensor data to create an accurate spatial map of a physical area.

Localization may refer to the position and orientation (e.g., pitch, yaw, roll) of an object in a 3D space. Localization of an object may be determined by processing measurements from sensors within visible range of the object (e.g., RGBD camera, high-resolution camera, etc.), from sensors within wireless range of the object (e.g., Wi-Fi access point, Bluetooth device, etc.), and/or from sensors attached to the object itself (e.g., gyroscope, accelerometer, magnetometer, GPS, RGBD camera, high-resolution camera, Wi-Fi, Bluetooth, etc.). Localization may be determined by comparing sensor measurements with mapped measurements stored in a spatial map of the environment. Localization accuracy may vary depending on the type of sensors used to obtain measurements, and/or the accuracy and latency of the measurements used to calculate localization.

Example use cases are provided herein.

Extended reality (XR) and Metaverse use cases may use (e.g., require) accurate WTRU localization across a diverse set of environments. For example, an XR application may use (e.g., need) real-time and precise WTRU localization information to correctly overlay augmented reality (AR) content (e.g., at an outdoor sporting event or at an indoor concert). In another example, a Metaverse AR application may use (e.g., need) WTRU localization information to determine whether spatial anchors in the digital world should be visible and discoverable by a WTRU (e.g., while at a park or moving around an indoor shopping mall).

Current positioning systems with WTRU localization capabilities may work under certain conditions and in specific environments. Indoor settings may use (e.g., require) vendor-specific wireless deployments and/or positioning techniques to obtain accurate WTRU localization. To enable widespread adoption of use cases (e.g., new use cases), means (e.g., new and efficient means) of obtaining accurate WTRU localization across a wide range of environments may be enabled. 3GPP systems may provide a standardized architecture. 3GPP systems may have extensive coverage (e.g., both outdoor and indoor). 3GPP may be a candidate (e.g., an ideal candidate) to address the desire (e.g., need) for widespread, accurate WTRU localization.

To enable XR and Metaverse use cases, and to enable accurate WTRU localization, wireless systems may create and manage a spatial map of the world. Spatial mapping technologies may be vendor-specific and/or have limited indoor coverage. Sensing technologies may be diverse. Sensing technologies may provide varying levels of measurement accuracy. Systems may enable consolidation and/or aggregation of sensing and/or spatial mapping technologies. Consolidation and/or aggregation may be enabled by the 3GPP system.

To support spatial mapping and localization, the 3GPP system may enable spatial map owners with spatial computing capabilities (e.g., spatial mapping and localization capabilities) to expose and offer spatial compute services to authorized users. The 3GPP system may enable spatial computing capabilities by providing spatial compute service registration and discovery procedures. Spatial compute services may offer a range of different processing and communication capabilities. Some spatial compute services may offer WTRU localization services that request (e.g., require) specific sensor data from a WTRU. Some (e.g., other) spatial compute services may support different sensor inputs. Some spatial compute services may prefer client-side processing. Discovery and selection of spatial compute services may consider the specifications (e.g., needs) and capabilities of the WTRU and the service.

Example enhancements are provided herein. For example, 5G system service discovery procedures may allow for discovering services based on service characteristics. 5G systems may not account for the diverse processing and communication specifications (e.g., requirements) that are associated with the service. During the discovery procedures, the client may discover a service that it may not be capable of using. The client may not be capable of using the discovered service because the WTRU that hosts the client is not associated with the sensors that are used (e.g., necessary) for spatial computing. The client may not be capable of using the discovered service because the WTRU that hosts the client is not able to establish a communication path (e.g., a PDU session and/or QoS flow) capable of providing the QoS that is used (e.g., necessary) for processing the spatial compute service media. The client may discover services that it is not able/willing to process because properly displaying the associated media would involve (e.g., require) the WTRU that hosts the client to sharing information from sensors (e.g., such as a gyroscope, a light sensor, a microphone, and a camera).

Some discovery mechanisms may use (e.g., require) the client to perform post-processing steps (e.g., to determine if the client is capable and willing to exchange and process media from a spatial compute service). System enhancements may minimize or eliminate the amount of post discovery processing that the client performs (e.g., needs to perform) to determine whether the client may (e.g., wants to) access the spatial compute service and process the associated media.

Feature(s) described herein may enable an application client (AC) on a WTRU to discover, select, and configure spatial compute services (e.g., to perform spatial mapping and localization operations). Feature(s) described herein may allow an AC to discover and select spatial computing services (e.g., only spatial compute services) that it is capable and willing to use.

Feature(s) described herein may enable access (e.g., pervasive and careful access) to spatial compute services across a wide range of environments (e.g., by leveraging 3GPP network coverage and providing spatial compute service discovery, selection, and configuration capabilities). A spatial compute management function (SCMF) may be used (e.g., as an enhancement to the 3GPP service enablement layer) to manage and configure spatial compute services.

If requested by an AC, a client enabler function (e.g., SCMF-C) on a WTRU may provide discovery filters, spatial sensor capabilities, and/or WTRU information to discover spatial compute services registered to a server enabler function (e.g., SCMF-S). The AC may select and/or configure a spatial compute service according to AC specifications (e.g., requirements) and capabilities, WTRU specifications (e.g., requirements) and capabilities (e.g., processing, communication, spatial sensing), and/or spatial compute service specifications (e.g., requirements) and capabilities.

Feature(s) described herein describe service enablement layer enhancements for spatial compute service management. A person of ordinary skill in the art will appreciate that these feature(s) may be applied to other service discovery and management scenarios. For example, the feature(s) described herein may apply to spatial anchors. The terms “spatial compute service” and “spatial anchor” may be used interchangeably. Spatial compute service information may refer to information about the AS associated with a spatial anchor.

Example terminology is provided herein. Common terminology may apply to feature(s) described herein.

An application client (AC) may refer to a user application that resides on a WTRU and communicates with an AS. A WTRU may use more than one (e.g., several) AC concurrently.

An application server (AS) may refer to an application server that resides in a DN (e.g., and may be a software server executing on generic hardware and providing a service to the AC). An AS may serve one or more AC instances (e.g., that may reside on different WTRUs).

An enabler client (EC) may refer to a service enabler that resides on a WTRU. The EC may communicate with an ES. The EC may provide client-side functionalities to ACs for a specific enablement service.

An enabler server(ES) may refer to a service enabler that resides in a DN. The ES may provide server-side functionalities to ASs for a (e.g., specific) enablement service. An ES may serve one or more EC instances (e.g., that may reside on different WTRUs).

Requester information may refer to information that characterizes a requester. Requester information may include a user identifier (e.g., unique ID), AC identifier (e.g., unique ID), and/or AC type.

WTRU information may refer to information that characterizes a WTRU. WTRU information may include a WTRU identifier (e.g., SUPI, GPSI, phone number), WTRU state, and/or WTRU capabilities, for example, supported radio access technologies (RAT), and/or processing capabilities. Processing capabilities may include processor type (e.g., CPU, GPU), spatial computing capabilities (e.g., spatial mapping and localization capabilities), and/or artificial intelligence/machine learning (AI/ML) processing capabilities.

WTRU state may represent information about the WTRU that characterizes the device state. The WTRU state may include power state (e.g., battery level), and/or connection state (e.g., signal quality, RAT).

A spatial sensor may refer to a sensor that may capture information about an object to determine the position of the object in space. A sensor may be collocated with the object (e.g., the object whose position is being determined). A sensor may be detached from the object. In an example, a gyroscope on a smartphone may be used to determine the orientation of the smartphone. In an example, a wall mounted RGBD camera may be used to determine the position of boxes as they are moved around a factory. In an example, a WTRU may comprise a spatial sensor. In an example, a spatial sensor may be a device that is separate from a WTRU. In an example, a first WTRU may use a spatial sensor that belongs to a second WTRU (e.g., the second WTRU may comprise the spatial sensor). In an example, a first WTRU may use a spatial senor that a second WTRU may be able to access (e.g., the second WTRU may have a Bluetooth connection to a spatial sensor device). A spatial map may be a 3D digital model of a physical environment.

Spatial mapping may involve collecting and/or processing sensor measurements at various positions to construct a map of the environment. Spatial mapping may use (e.g., require) sensor location information, wireless sensing data, and/or non-3GPP sensor data to create an accurate spatial map of a physical area.

Localization may refer to the process of determining localization information.

Localization information may refer to information that describes the position and orientation (e.g., pitch, yaw, roll) of an object in a 3D space. Localization information may be determined by processing and comparing measurements from sensors with a spatial map of the environment. Localization information accuracy may vary depending on the type of sensors used to obtain measurements, and/or the accuracy and latency of the measurements used to calculate localization information.

A spatial compute service may refer to a service with spatial computing capabilities that supports operations such as spatial mapping and localization. A spatial compute service may own (e.g., or have access to) a spatial map of a physical environment. The spatial compute service capabilities may be defined in the spatial compute service information.

Spatial compute service information may refer to information that characterizes a spatial compute service. Spatial compute service information may include a spatial compute service identifier (e.g., unique identifier), spatial compute service type, spatial compute service address (e.g., FQDN, URI, IP, endpoint), spatial map information, spatial mapping capabilities, localization capabilities, an indication of support for client and/or server side spatial computing (e.g., whether the spatial compute service is configured to perform spatial mapping and/or localization operations, or configured as storage for spatial mapping and localization information), and/or an indication about whether the spatial compute service is sponsored (e.g., whether and how the user may be charged to use the service).

Spatial compute service information filters may refer to filters used to identify matching spatial compute services. Spatial compute service information filters may include information elements that may match any information from the spatial compute service information. For an (e.g., each) information element in the spatial compute service information, the filters may include matching criteria (e.g., exact values, a wildcard, ranges, regular expressions).

Spatial compute service configuration information may refer to information that characterizes the configuration of a spatial compute service. Spatial compute service configuration information may include information elements that configure information (e.g., any information) from the spatial compute service information. For an (e.g., each) information element in the spatial compute service information, the spatial compute service configuration may include configuration information (e.g., selected types, formats, capabilities).

Spatial map information may refer to information that characterizes a spatial map. Spatial map information may include a spatial map identifier (e.g., unique identifier), spatial map owner identifier (e.g., MNO, city, environment owner, 3rd party vendor), spatial map type (e.g., “localization map” for localization, “surface map” for applying textures), spatial map format (e.g., point-cloud, mesh, visual), spatial map coverage area (e.g., geographic area, civic address, building identifier, building floor), spatial map accuracy (e.g., overall spatial map accuracy, position-specific map of accuracies, accuracy confidence vectors, completeness indicators), spatial map status (e.g., complete, partial), spatial map data (e.g., the latest spatial map data), spatial map address (e.g., FQDN, URI, IP, endpoint), latest update date and time, availability information (e.g., free, cost), and/or license for use (e.g., MIT, GPL, etc.).

Spatial mapping capabilities may include spatial mapping specifications (e.g., requirements) for creating or updating a spatial map. Spatial mapping specifications may include spatial sensor information, processing specifications (e.g., CPU, GPU), supported media formats, support for AI/ML models, and/or spatial mapping accuracy. Spatial mapping capabilities may indicate the capability to update a spatial map (e.g., read-write, read-only).

Localization capabilities may include localization specifications for obtaining localization information from a spatial map. Localization specifications may include spatial sensor information, processing specifications (e.g., CPU, GPU), supported media formats, support for AIML models, and/or localization accuracy.

Spatial sensor information may refer to information that characterizes a spatial sensor. Spatial sensor information may include a spatial sensor identifier (e.g., unique identifier), spatial sensor type (e.g., RGBD camera, light detection and ranging (LiDAR) camera, high-resolution camera), spatial sensor position (e.g., geographic position, localization information), spatial sensor state (e.g., availability), spatial sensor configuration (e.g., power level, zoom level, resolution), spatial sensor measurement capabilities (e.g., accuracy, QoS specifications/requirements), spatial sensor access permissions (e.g., whether AC is allowed to access sensor information), spatial sensor information sharing permissions (e.g., whether the AC is allowed to send sensor information), and/or spatial sensor control information.

Spatial sensor control information may refer to information that characterizes the controllability of a spatial sensor. Spatial sensor control information may include spatial sensor control capabilities such as spatial sensor mobility (e.g., geographic area, 2D and/or 3D position range), spatial sensor rotation (e.g., camera orientation angle range), and/or spatial sensor zoom (e.g., camera resolution range). Spatial sensor control information may include control session QoS specifications/requirements.

Feature(s) associated with a spatial compute management function are provided herein.

Enhancements may be made to the 3GPP service enablement layer and/or 5G core network to enable discovery, management, and configuration of spatial computing services (e.g., for creating or updating spatial maps or determining accurate WTRU localization). These enhancements may be defined in a spatial compute management function (SCMF), as described herein.

In some examples (e.g., in a 3GPP system), an SCMF may provide spatial compute enablement services to the WTRU (e.g., AC) and network (e.g., AS). Spatial compute enablement services may include procedures for registering, discovering, and configuring spatial compute services.

Example deployment options are provided herein.

In some deployments (e.g., in a 3GPP deployment), a WTRU may request services from an AS. The WTRU may establish a connection to access the AS. The connection may be via the 3GPP network. The SCMF may follow a client-server model by splitting the SCMF into client and server components. The SCMF client (SCMF-C) may be located on a WTRU or terminal component. The SCMF server (SCMF-S) may be accessible via or located within a network. The SCMF-C and SCMF-S (e.g., together) provide SCMF services to applications. For example, the applications that consume the services may run in the WTRU, be referred to as an Application Client (AC), and/or use functionality on the WTRU and provided by the SCMF-C. The applications that provide the services may run in the network and be referred to as an Application Server (AS).

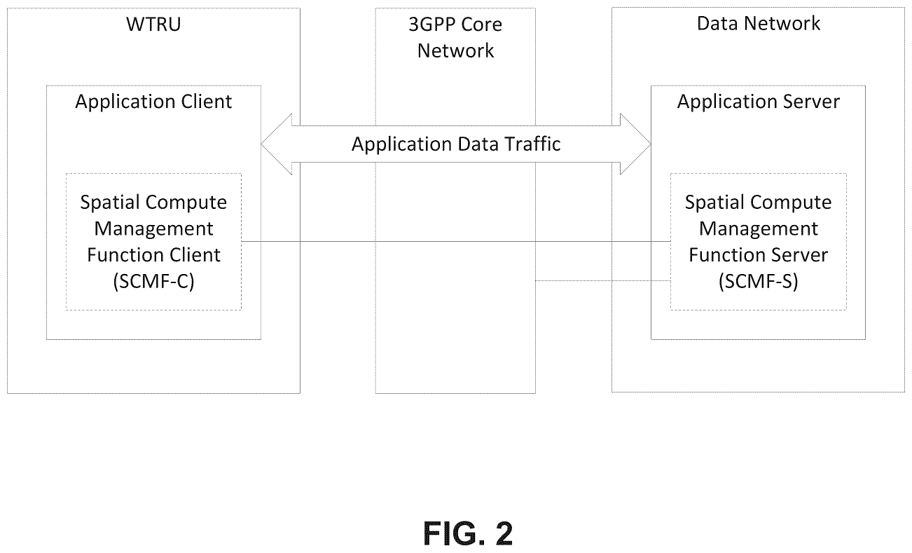

FIG. 2 illustrates an example SCMF deployed in an AC and/or AS.

An SCMF client and server functionality may be deployed within an application. FIG. 2 illustrates an SCMF deployed within an AC on a WTRU, and in an AS within a data network. For example, the SCMF functionality may be packaged in a library that is statically linked with the AC or AS, or dynamically loaded by the AC or AS.

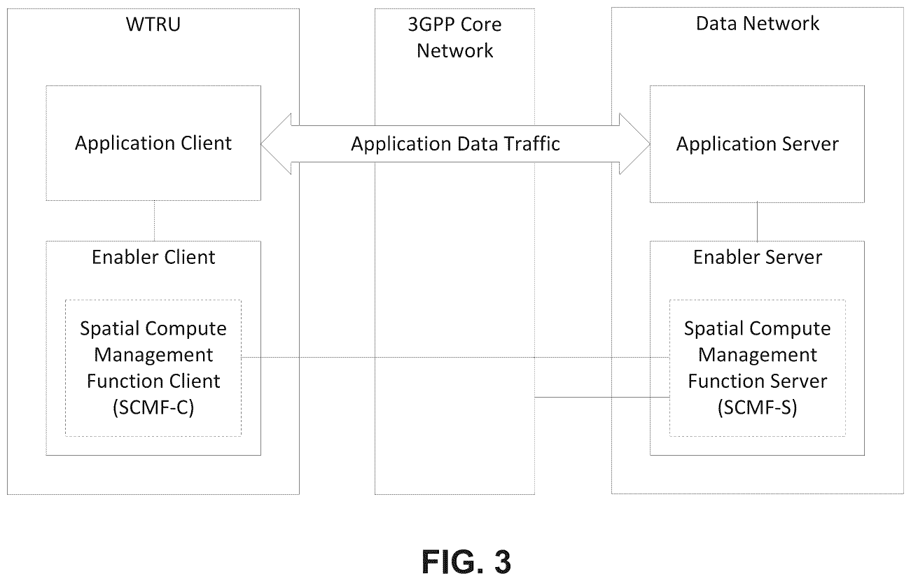

FIG. 3 illustrates an example SCMF deployed in an EC and/or ES.

An SCMF may be deployed as a standalone functional element in a WTRU or in a data network. FIG. 3 shows an SCMF deployed as an enabler client on a WTRU and as an enabler server in a data network. The AC and AS may access functionality provided by the enabler client and enabler server, respectively, via a determined API or interface.

Different combinations of the deployments described herein are possible.

The SCMF-S may be deployed in an ES that does not reside in the same DN as the AS. For example, an ES may be deployed in a central MNO DN, EDN, another DN, or a cloud DN.

The SCMF-C may be deployed in an EC that does not reside on the same WTRU as the AC. For example, an AC deployed on a TE may use AT commands to interact with an EC deployed in the MT part of the WTRU. For example, an AC deployed on a TE may interact with an EC that is (e.g., also) deployed in the TE part of the WTRU. For example, an AC may use a tethered connection (e.g., a D2D connection such as Bluetooth, WiFi, or PC5) to communicate with an EC that runs in the WTRU.

In an example (e.g., a network-only example), SCMF capabilities may be provided by (e.g., entirely by) the SCMF-S.

Feature(s) associated with spatial compute service management are provided herein. Feature(s) associated with spatial compute service registration are provided herein.

The SCMF may support spatial compute service registration. Spatial compute service registration may allow a spatial map owner to expose its spatial computing capabilities (e.g., spatial mapping and localization capabilities) to application clients (e.g., via the 5GS). The SCMF may use information about the registered spatial compute services during spatial compute service discovery. By supporting spatial compute service registration, the SCMF may leverage existing spatial mapping, localization services, and/or data sets to increase coverage and support for WTRU localization in indoor and outdoor settings.

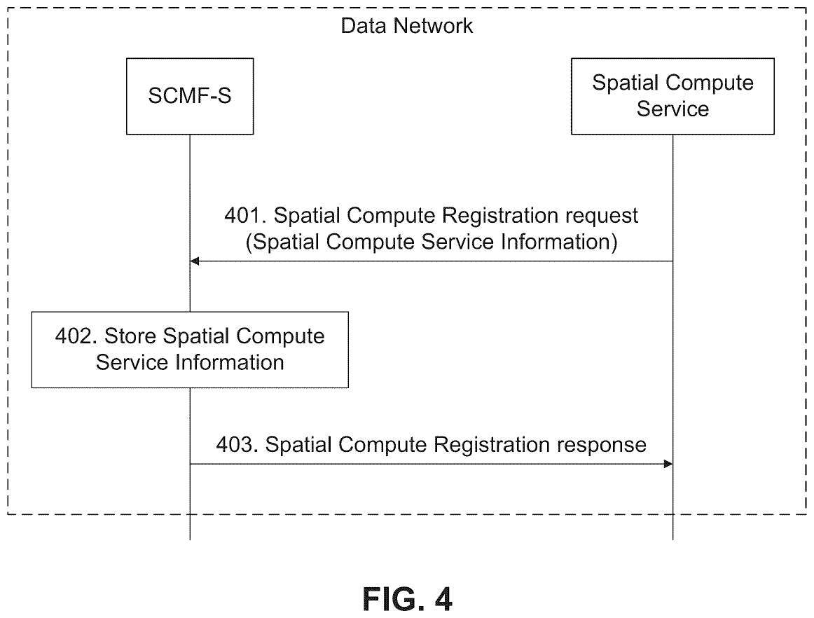

FIG. 4 illustrates an example procedure for spatial compute service registration. FIG. 4 illustrates example signaling associated with spatial compute registration.

At 401, the spatial compute service provider (e.g., spatial map owner AS) may send a spatial compute registration request to the SCMF-S. The spatial compute registration request may include spatial compute service information described herein. For example, a sporting arena owner with an MNO partnership and a pre-existing spatial map of the arena may want to offer WTRU localization services to MNO subscribers (e.g., to enable AR content during a sporting event). The registration request may indicate that the spatial compute service supports precise WTRU localization using a point-cloud representation (e.g., spatial map) of the arena and image captures from the WTRU. The spatial compute service may indicate that its spatial map of the arena is available to application clients at a specific URI. The spatial compute service may indicate that the spatial map may be used for AR rendering in the client WTRU.

If a registration exists (e.g., already exists) for a spatial compute service, the spatial compute service provider may send a spatial compute registration update request to the SCMF-S (e.g., to provide updates to any of the spatial compute service information).

At 402, the SCMF-S may determine whether the spatial compute service provider is authorized to register a spatial compute service. If authorized, the SCMF-S may store the spatial compute service information. Otherwise (e.g., if the spatial compute service provider is not authorized), the SCMF-S may indicate an error in the response. The SCMF-S may store the spatial compute service information for an authorized spatial compute service provider in a local database.

At 403, the SCMF-S may send a spatial compute registration response to the spatial compute service provider. The spatial compute registration response may include an indication about whether the spatial compute service was successfully registered. The spatial compute registration response may include a unique registration identifier that may be used during subsequent calls to the SCMF-S to identify the stored compute service information.

Feature(s) associated with spatial compute service discovery are provided herein.

The SCMF may support spatial compute service discovery. Spatial compute service discovery may enable an AC on a WTRU to discover spatial compute services that match the provided spatial compute service filters. Discovered spatial compute services may be determined based on spatial compute service capabilities and specifications/requirements, AC capabilities and specifications/requirements, and/or WTRU capabilities and specifications/requirements (e.g., processing capabilities, sensing capabilities). Spatial compute services may be (e.g., must be) registered to the SCMF in order to be discoverable. The AC may select one or more spatial compute service instances with which to configure and establish a service session (e.g., after discovering spatial compute services).

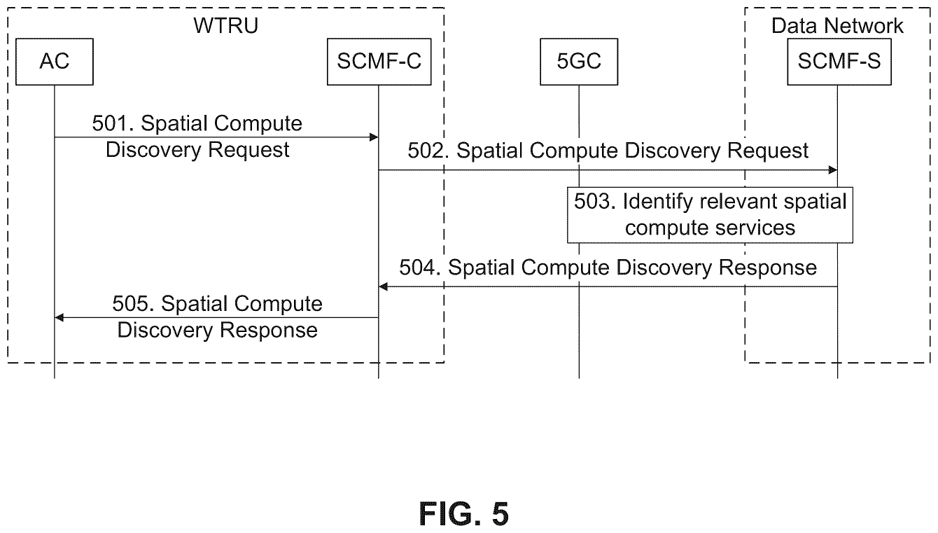

FIG. 5 illustrates an example procedure for spatial compute service discovery. FIG. 5 illustrates example signaling associated with spatial compute service discovery.

The spatial compute service registration procedure may be performed to register one or more spatial compute services (e.g., as a prerequisite).

At 501, an AC on a WTRU may trigger discovery of spatial compute services that may provide the services used (e.g., required) by the AC. For example, an AR application on a WTRU may use (e.g., require) a spatial map of an indoor environment (e.g., to derive precise WTRU localization information to correctly position AR content in the application viewport). The AR application may trigger discovery of spatial compute services capable of providing the spatial map (e.g., the required spatial map) of the indoor environment.

The AC may send a spatial compute discovery request to the SCMF-C. The spatial compute discovery request may include spatial compute service information filters, spatial sensor information, and/or requester information (e.g., as described herein). Spatial compute service information filters may indicate the application layer specifications (e.g., requirements) for spatial compute services. Spatial sensor information may indicate the spatial sensing capabilities of the WTRU.

For example, an indoor navigation application on a WTRU may use (e.g., require) WTRU localization services to obtain coarse WTRU localization information (e.g., used to correctly position and orient a marker in the application). In this case, the spatial compute service information filters may indicate the localization capabilities (e.g., the required localization capabilities).

For example, an AR application on a WTRU with limited processing capabilities may use (e.g., require) WTRU localization services that support server-side computing of WTRU localization information. In this case, the spatial compute service information filters may indicate a request (e.g., need) for server-side spatial computing.

For example, a spatial mapping application on a robot may use (e.g., require) spatial mapping services in which sensor data may be sent to create or update a spatial map of the location area of interest.

In this case, the spatial compute service information filters may indicate the spatial mapping capabilities (e.g., the required spatial mapping capabilities). The spatial sensor information may indicate the supported robot sensors and sensing capabilities.

At 502, the SCMF-C may send a spatial compute discovery request to the SCMF-S. The spatial compute discovery request may include the spatial compute service information filters and/or spatial sensor information obtained from the AC in the discovery request. The spatial compute discovery request may include WTRU information, as described herein. The spatial compute discovery request may include an identifier of the SCMF-C. The identifier of the SCMF-C may be a user identifier (e.g., the format of the identifier may be a user identifier such as an NAI). WTRU information may be used as a discovery filter by the SCMF-S to identify relevant spatial compute services.

For example, a WTRU with a powerful GPU may support client-side or server-side rendering and localization. In this case, the WTRU information may indicate details about the supported GPU.

For example, a WTRU with the ability to process AI/ML models may support client-side spatial computing for spatial mapping and localization. In this case, the WTRU information may indicate details about the supported Al/ML processing capabilities.

At 503, the SCMF-S may identify spatial compute services that are registered to the SCMF, that match the spatial compute service information filters provided in the discovery request, and/or that are supported by (e.g., compatible with) the WTRU processing and spatial sensing capabilities (e.g., indicated in the WTRU information and spatial sensor information in the discovery request). The SCMF-S may invoke APIs (e.g., 5GC network APIs, for example, via the NEF) to obtain the latest WTRU location information. The latest WTRU location information may be used to identify spatial compute services with a matching coverage area.

For example, the SCMF-S may use the SUPI provided in the WTRU information to request WTRU location information from the network (e.g., the 5GC). Based on the WTRU location, the SCMF-S may determine that there are one or more (e.g., multiple) spatial compute services available in the area. If the discovery request requests (e.g., requires) precise WTRU localization services, the SCMF-S may identify the spatial compute services that support the requested service. Based on the spatial sensing specifications/requirements of the identified spatial compute services, and/or based on the spatial sensing capabilities of the WTRU provided in the spatial sensor information of the discovery request, the SCMF-S may determine the list of spatial compute services that support service to (e.g., the needs of) the application and that are supported by the capabilities of the WTRU.

At 504, the SCMF-S may send a spatial compute discovery response to the SCMF-C. The spatial compute discovery response may include a list of spatial compute service information for the identified (e.g., discovered) spatial compute services.

At 505, the SCMF-C may send a spatial compute discovery response to the AC. The spatial compute discovery response may include the list of spatial compute service information (e.g., obtained from the SCMF-S in the discovery response). The set of spatial compute services may include one or more spatial compute services (e.g., a set of spatial compute services) that the AC or WTRU may utilize. For example, the discovery response may indicate that a set of spatial compute services may match a requested characteristic or may be compatible with a sensor and/or the WTRU. For example, the discovery response may comprise one or more spatial compute services (e.g., a set) that can be used (e.g., are compatible) with the spatial sensing and computing capabilities of the WTRU.

The spatial compute discovery response may indicate or may comprise a QoS parameter (e.g., requirement). The QoS parameter (e.g., requirement) may be associated with a sensor data flow. For example, the QoS parameter may indicate the QoS that may be provided by a sensor data flow. The QoS parameter may be associated with a spatial compute service. In an example, a set of spatial compute services may be provided, where each service of the set may be associated with a QoS parameter (e.g., requirement). In examples, the QoS parameter (e.g., requirement) may indicate the QoS that is to be maintained in order to use a sensor data flow, a spatial compute service, and the like.

The AC may select one or more spatial compute services. The AC may perform the spatial compute service configuration procedure to configure the spatial compute service and the network in preparation for a service session.

The AC may select one or more spatial compute services based on one or more criteria, including priority, characteristics, compatibility, QoS requirements, and the like. The AC may select one or more spatial compute services based on priority, which may involve ranking services based on their importance, urgency, preference, cost, and the like. For example, one or more spatial compute services may be ranked based on priority according to user and/or operational references. The AC may select one or more spatial compute services based on characteristics, which may refer toa features of a service that makes it suitable for a task, such as the ability to process complex spatial data or compatibility with existing hardware and software configurations. The AC may select one or more spatial compute services based on a performance metric, such as QoS, latency, bandwidth, reliability, guaranteed bit rate, packet error rate, and the like.

Feature(s) associated with spatial compute service configuration are provided herein.

The SCMF may support spatial compute service configuration. Spatial compute service configuration may enable an AC on a WTRU to configure the selected spatial compute services and/or network flows (e.g., before establishing a service session). Configuration information may be determined using AC specifications and capabilities, WTRU specifications and capabilities, and/or spatial compute service specifications and capabilities. Configuration information may be provided to the SCMF. The SCMF may use the configuration information to configure the spatial compute service. The SCMF may use the configuration information to configure the (e.g., required) service flows in the network. The AC may establish a service session with the configured spatial compute service (e.g., after spatial compute service configuration is complete).

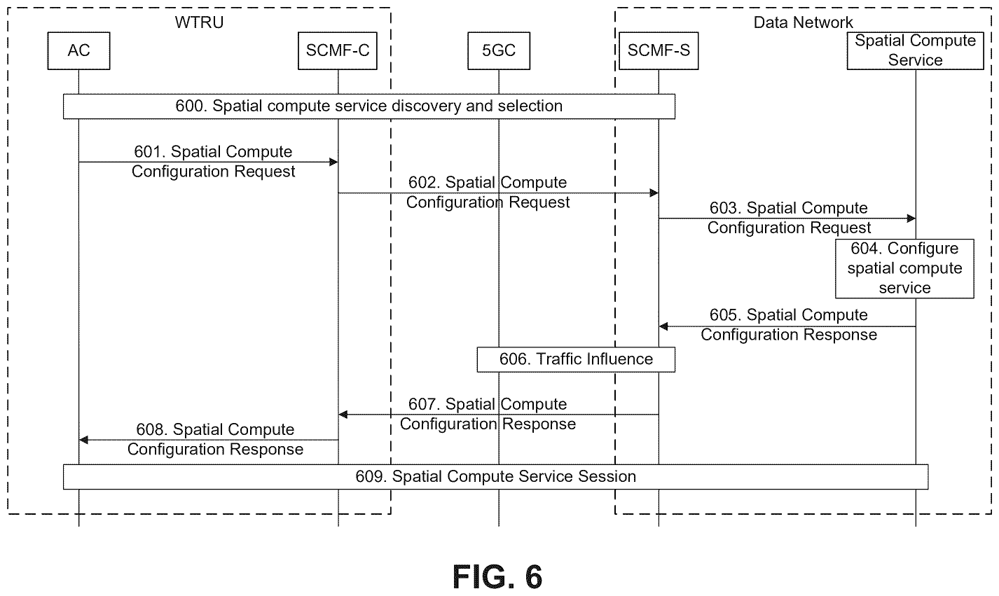

FIG. 6 illustrates an example procedure for spatial compute service configuration. FIG. 6 illustrates example signaling associated with spatial compute service configuration.

An AC may (e.g., as a prerequisite) perform the spatial compute service discovery procedure. The AC may discover at least one relevant and available spatial compute service. The AC may select one or more spatial compute services. The AC may trigger a request for spatial compute service configuration.

At 601, an AC on a WTRU may send a spatial compute configuration request to the SCMF-C. The spatial compute configuration request may include spatial compute service configuration (e.g., described herein) to configure the selected spatial compute service and network. The SCMF-C may use the spatial compute service configuration to determine the service flows and/or spatial sensing data flows to be used (e.g., required) by the AC. The SCMF-C may use the spatial compute service configuration to determine the QoS parameters or specifications (e.g., guaranteed bit rate, packet error rate, etc.) for the flows. The QoS parameters or specifications may be any of the performance metrics, QoS parameters, or QoS requirements described herein, such as QoS, latency, bandwidth, reliability, guaranteed bit rate, packet error rate, and the like.

The QoS specifications may be a list of specifications such as guaranteed bit rate, packet error rate, and/or packet delay budget. The QoS specification may be expressed as a QoS reference. A QoS reference may refer to a value (e.g., an integer value) that maps to a list of specifications such as guaranteed bit rate, packet error rate, and packet delay budget. The SCMF-C may be pre-configured to know the mapping between QoS reference and a list of specifications (e.g., the configuration may be based on a service layer agreement).

Although not shown in FIG. 6, the SCMF-C may invoke APIs (e.g., 5GC network APIs, for example, via the NEF) to set the requested (e.g., required) QoS for the service and/or spatial sensing data flows. Determining the flows and QoS specifications at the service enablement layer may allow the AC to be designed independently of the transport network. The AC may not be (e.g., may not need to be) aware of the underlying network.

For example, a spatial mapping application on a drone with RGBD and LiDAR cameras may have discovered a spatial compute service with client-side and server-side spatial computing capabilities that accepts LiDAR sensor data to create a spatial map of an environment. The spatial mapping application on the drone may select the discovered spatial compute service. The spatial mapping application may use the SCMF-C to configure the selected service by indicating (e.g., in the configuration information) that server-side spatial computing is to be used (e.g., required). The spatial mapping application may use the SCMF-C to configure the selected service by indicating that LiDAR sensor data may be provided. The SCMF-C may (e.g., upon receiving the configuration request from the AC) obtain the QoS specifications for spatial mapping media flows and/or LiDAR sensing data flows. The SCMF-C may invoke the 5GC NEF to set the QoS (e.g., the required QoS).

At 602, the SCMF-C may send a spatial compute configuration request to the SCMF-S. The spatial compute configuration request may include the spatial compute service configuration (e.g., obtained from the AC in the configuration request) and the WTRU information described herein. The spatial compute configuration request may include an identifier of the SCMF-C. The identifier of the SCMF-C may be a user identifier (e.g., the format of the identifier may be a user identifier such as an NAI). WTRU information may be used (e.g., by the SCMF-S) during network flow configuration (e.g., in the 5GC).

At 603, the SCMF-S may send a spatial compute configuration request to the spatial compute service. Although not shown in FIG. 6, the SCMF-S may send a spatial compute configuration notification to the spatial compute service. The spatial compute configuration request or notification may include the configuration information (e.g., obtained from the SCMF-C in the configuration request).

At 604, the spatial compute service may use the configuration information to configure itself. For example, a localization service may receive configuration information that indicates server-side spatial computing to process an RGBD camera stream to calculate WTRU localization. The localization service may reserve compute resources to handle the incoming localization request.

At 605, the spatial compute service may send a spatial compute configuration response to the SCMF-S. The spatial compute configuration response may include an indication of success or failure to configure the spatial compute service. For example, a spatial mapping service may indicate that it has been successfully configured to receive and process WTRU sensor input.

At 606, the SCMF-S may use the spatial compute configuration response result and the spatial compute service configuration to determine the service flows and spatial sensing data flows between (e.g., requested between) the AC and the configured spatial compute service. The SCMF-S may determine the QoS specifications (e.g., guaranteed bit rate, packet error rate, etc.) for the flows (e.g., based on the spatial compute configuration response result and the spatial compute service configuration). The SCMF-S may invoke APIs (e.g., 5GC network APIs, for example, via the NEF) to set the QoS (e.g., the requested QoS) for the service and/or spatial sensing data flows. For example, the SCMF-S may determine that a spatial mapping application on a WTRU has configured with a spatial mapping service to accept LiDAR and RGBD sensor input to update a spatial map. Based on this information, the SCMF-S may configure the QoS flows in the 5GC for the sensor data media flows.

At 607, the SCMF-S may send a spatial compute configuration response to the SCMF-C. The spatial compute configuration response may include an indication of success or failure to configure the spatial compute service and/or the network flows.

At 608, the SCMF-C may send a spatial compute configuration response to the AC. The spatial compute configuration response may include an indication of success or failure to configure the spatial compute service and/or the network flows.

At 609, if the AC has received a successful spatial compute configuration response, the AC may establish a service session with the spatial compute service. If the AC has received a failure response, the AC may perform spatial compute service configuration (e.g., using a different configuration), or perform spatial compute discovery to discover new or updated spatial compute services. For example, a spatial mapping application may send sensor information to the spatial compute service configured to perform server-side spatial computing. The spatial mapping application may request a spatial map of the WTRU environment to perform client-side spatial computing with local sensor data to obtain WTRU localization information.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments.

The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

What is claimed:

1. A wireless transmit/receive unit (WTRU) comprising:
a processor configured to:
receive, from an application client, an indication of a spatial compute service characteristic;
determine a spatial sensing capability of the WTRU based on the spatial compute service characteristic;
send a spatial compute discovery request to a first network node, wherein the spatial compute discovery request indicates the spatial sensing capability and a spatial computing capability of the WTRU;
receive a spatial compute discovery response from the first network node, wherein the spatial compute discovery response indicates a set of spatial compute services performable using the spatial sensing capability and the spatial computing capability of the WTRU, and a quality of service (QOS) requirement associated with a sensor data flow;
send a QoS configuration request to a third network node, wherein the QoS configuration request indicates a request for the third network node to configure QoS for a PDU session that carries the sensor data flow;
send a spatial compute configuration request to the first network node, wherein the spatial compute configuration request indicates a request for the first network node to configure a second network node such that the WTRU can use at least one spatial compute service from the set of spatial compute services; and
send data from a sensor in the PDU session.

2. The WTRU of claim 1, wherein the processor is further configured to:
receive a spatial compute configuration response that indicates that the second network node has been successfully configured;
send spatial service request message to the second network node, wherein the spatial service request message comprises sensor data and indicates a request for the at least one spatial compute service to generate spatial data using the sensor data; and
receive a spatial service response message from the second network node, wherein the spatial service response message comprises the generated spatial data.

3. The WTRU of claim 1, wherein the spatial compute discovery request is a first spatial compute discovery request, and the processor is further configured to:
receive a spatial compute configuration response that indicates a failure to configure the second network node; and
in response to the spatial compute configuration response, send a second spatial compute discovery request to the first network node.

4. The WTRU of claim 1, wherein the processor is further configured to receive WTRU positioning information from the at least one spatial compute service.

5. The WTRU of claim 1, wherein the processor is further configured to send the spatial compute discovery response to the application client.

6. The WTRU of claim 1, wherein the spatial compute configuration request further indicates a processing capability of the WTRU.

7. The WTRU of claim 1, wherein the processor is further configured to:
receive a spatial compute configuration response that indicates successful configuration of the at least one spatial compute service, a spatial sensing data flow associated with the at least one spatial compute service, and a service flow associated with the at least one spatial compute service.

8. The WTRU of claim 1, wherein spatial compute services in the set of spatial compute services further satisfy a criterion, and wherein the criterion comprises at least one of a guaranteed bit rate, a packet error rate, a packet delay budget, a quality of service (QOS) value, a processing capability, a supported radio access technology, or a battery level.

9. A method, to be performed by a wireless transmit/receive unit (WTRU) comprising a sensor, the method comprising:
receiving, from an application client, an indication of a spatial compute service characteristic;
determining a spatial sensing capability of the WTRU based on the spatial compute service characteristic;
sending a spatial compute discovery request to a first network node, wherein the spatial compute discovery request indicates the spatial sensing capability and a spatial computing capability of the WTRU;
receiving a spatial compute discovery response from the first network node, wherein the spatial compute discovery response indicates a set of spatial compute services performable using the spatial sensing capability and the spatial computing capability of the WTRU, and a quality of service (QOS) requirement associated with a sensor data flow;
sending a QoS configuration request to a third network node, wherein the QoS configuration request indicates a request for the third network node to configure QoS for a PDU session that carries the sensor data flow;
sending a spatial compute configuration request to the first network node, wherein the spatial compute configuration request indicates a request for the first network node to configure a second network node such that the WTRU can use at least one spatial compute service from the set of spatial compute services; and
sending data from a sensor in the PDU session.

10. The method of claim 9, wherein the method further comprises:
receiving a spatial compute configuration response that indicates that the second network node has been successfully configured;
sending spatial service request message to the second network node, wherein the spatial service request message comprises sensor data and indicates a request for the at least one spatial compute service to generate spatial data using the sensor data; and
receiving a spatial service response message from the second network node, wherein the spatial service response message comprises the generated spatial data.

11. The method of claim 9, wherein the spatial compute discovery request is a first spatial compute discovery request, and the method further comprises:
receiving a spatial compute configuration response that indicates a failure to configure the second network node; and
in response to the spatial compute configuration response, sending a second spatial compute discovery request to the first network node.

12. The method of claim 9, wherein the method further comprises receiving WTRU positioning information from the at least one spatial compute service.

13. The method of claim 12, wherein the method further comprises sending the spatial compute discovery response to the application client.

14. The method of claim 9, wherein the spatial compute configuration request further indicates a processing capability of the WTRU.

15. The method of claim 9, wherein the method further comprises:
receiving a spatial compute configuration response that indicates successful configuration of the at least one spatial compute service, a spatial sensing data flow associated with the at least one spatial compute service, and a service flow associated with the at least one spatial compute service.

16. The method of claim 9, wherein spatial compute services in the set of spatial compute services further satisfies a criterion, and wherein the criterion comprises at least one of a guaranteed bit rate, a packet error rate, a packet delay budget, a quality of service (QOS) value, a processing capability, a supported radio access technology, or a battery level.
